(19) United States
(12) Patent Application Publication
(10) Pub. No.: US 2008/0025577 A1
(43) Pub. Date: Jan. 31, 2008

(54) Photographic image distinction method and photographic image processing apparatus

(76) Inventors: Koichi Kugo, Wakayama-shi (JP); Noriyuki Nishi, Naga-Gun (JP)

Correspondence Address: SMITH PATENT OFFICE, 1901 PENNSYLVANIA AVENUE N W, SUITE 901, WASHINGTON, DC, 20006, US

(21) Appl. No.: 11/826,617

(22) Filed: Jul. 17, 2007

(30) Foreign Application Priority Data
Jul. 28, 2006 (JP) 2006-206692

(51) Int. Cl. G06K 9/00

(52) U.S. Cl. 382/118

(57) ABSTRACT

A photographic image processing apparatus, which detects a skin domain appropriately by using a simple method, and automatically distinguishes whether or not it corresponds to a harmful image, is provided with a face information extraction unit (41) which detects a face domain of a person from inputted color image data so that color difference data of the skin is extracted from the face domain, a skin domain detecting unit (42) which detects an area that is correlated with the color difference data of the skin as a skin domain from the color image data, a domain distinction unit (43) which distinguishes domain continuity between the face domain and the skin domain, and an image distinction unit (45) which calculates the ratio of areas between the face domain and the skin domain that are distinguished as a continuous domain by the domain distinction unit (43), so that based upon the ratio of the areas, it is distinguished whether or not any non-clothed portrait image is included in the color image data.

### BACKGROUND OF THE INVENTION

1. Field of the invention

The present invention relates to a photographic image distinction method that automatically distinguishes whether or not there is any non-clothed portrait image as a photographic subject in inputted color image data, and also concerns a photographic image processing apparatus using the method.

2. Description of the related art

In a photograph print shop or a mini-lab., which is a small business that develops film and makes prints quickly often using computerized equipment, or the computerized equipment itself, when an operator carries out print processing on film images and digital images picked up with a digital camera that have been entrusted by a customer by using a photograph printing apparatus, the operator displays thumbnail images corresponding to frame images, each of which means an image developed into a photographic film corresponding to a frame or recorded by a digital camera and the like, and is to be referred to simply as “a frame image” hereinafter, to be printed on a monitor screen of the photograph print apparatus, and carries out an image inspection process for manually correcting colors, concentrations and the like. At this time, when the operator finds any harmful image such as a pornographic image that offends public order and morals, in which a person without clothes is picked up as a subject, he or she can perform a setting operation to avoid conducting print processing on the corresponding image.

Further, the photograph printing apparatus of this kind is also provided with an automatic processing mode that automatically adjusts colors, concentrations and the like to generate a proper photograph print without the necessity of carrying out the image inspection process by the operator.

Therefore, in the case where a photograph print is generated in the automatic processing mode and shipped, in terms of promoting efficiency of the work by the operator, reducing personnel expenses, etc., there is a possibility that the above-mentioned harmful image which should not be shipped might be shipped accidentally.

Here, with respect to the technique for preventing circulation of harmful images over the Internet, proposed in Japanese Laid-Open Patent Publication No. 2004-102662 is a filtering data server in which, by installing a filtering database that can be shared by a plurality of users, information such as harmful information and the like are stored in the shared filtering database, thereby eliminating door-to-door sellers, telemarketing calls, accesses to harmful information over the Internet, etc.

Moreover, with respect to the image analyzing technique for determining whether or not it is a harmful image, the following technique is disclosed in Japanese Laid-Open Patent Publication No. 2002-175527. First, it is determined which one of predetermined combination patterns of areas a plurality of skin color domains extracted from image data divided into domains belong to, and feature values of the skin color distribution are obtained based upon the areas and the centers of gravity of the plurality of skin color domains. Next, with respect to each of the individual skin color domains, the feature value of the skin color distribution is compared with the standard set according to the patterns that matches the combination pattern of area to which the skin color domain is determined to belong, and the images that are not determined as harmful images are excluded. Those images that are not excluded are compared with patterns of predetermined face image data, so that the images that are not determined as harmful images are further excluded; thus, the images that have not been excluded yet are determined as harmful images.

However, the filtering data server disclosed in Japanese Laid-Open Patent Publication No. 2004-102662 exerts its effects only on images that are shared in the above-mentioned filtering server, and fails to provide a specific technique for analyzing whether or not an individual image is a harmful image.

Moreover, the method of discriminating harmful images disclosed in Japanese Laid-Open Patent Publication No. 2002-175527 is a method in which comparison is made between composition patterns of skin domains divided based upon edges of brightness or hue and composition patterns of skin domains obtained by analyzing a large number of pornographic photo samples to find the degree of coincidence; however, since there are considerable differences in the hues of the skin domain depending on races, it is not easy to appropriately extract skin domains such as a head portion and a torso portion from a subject image, and complicated processes are required for the discrimination process to cause a heavy processing load, with the result that it is difficult to apply this method to a photograph printing apparatus that needs to process a large number of photographic images within a short time.

### SUMMARY OF THE INVENTION

In order to solve the foregoing problems, an object of the present invention is to provide a photographic image distinction method which detects a skin domain appropriately by using a simple method, and automatically distinguishes whether or not it corresponds to a harmful image, and a photographic image processing apparatus using the method.

In order to achieve the above-mentioned object, a photographic image distinction method in accordance with the present invention includes: a face information extracting step of detecting a face domain of a person from inputted color image data so that color difference data of the skin is extracted from the face domain; a skin domain detecting step of detecting an area that is correlated with the color difference data of the skin extracted in the face information extracting step as a skin domain from the color image data; a domain distinction step of distinguishing domain continuity between the face domain and the skin domain detected in the skin domain detecting step; and an image distinction step of calculating the ratio of areas between the face domain and the skin domain that are distinguished as a continuous domain in the domain distinction step, so that based upon the ratio of the areas, it is distinguished whether or not any non-clothed portrait image is included in the color image data.

Moreover, another photographic image distinction method in accordance with the present invention includes: a face information extracting step of detecting a face domain of a person from inputted color image data so that color difference data of the skin, the direction and the size are extracted from the face domain; a skin domain detecting step of detecting an area that is correlated with the color difference data of the skin extracted in the face information extracting step as a skin domain from the color image data; a specific domain estimating step of estimating a specific domain corresponding to a specific portion of the person based upon the direction and the size of the face domain; and an image distinction step of calculating the ratio of areas between the skin domain and the non-skin domain in the specific domain estimated in the specific domain estimating step based upon the detected information in the skin domain detecting step, so that based upon the ratio of the areas, it is distinguished whether or not any non-clothed portrait image is included in the color image data.

Other aspects of the present invention will become apparent from the following description of preferred embodiments.

### BRIEF DESCRIPTION OF THE DRAWINGS

FIG. 1 is a functional block diagram showing a photographic image distinction unit in accordance with the present invention;

FIG. 2 is an explanatory diagram showing a photograph print order system;

FIG. 3 is an explanatory diagram showing a reception terminal;

FIG. 4 is an appearance view of a photographic image processing apparatus;

FIG. 5 is an explanatory diagram showing the photographic image processing apparatus;

FIG. 6A is an explanatory diagram showing a face domain detected from a photographic image;

FIG. 6B is an explanatory diagram showing a skin domain detected from the photographic image;

FIG. 6C is an explanatory diagram showing a domain continuity of the skin domain detected from the photographic image;

FIG. 7A is an explanatory diagram of a labeling process showing a state where a label is attached to a first pixel;

FIG. 7B is an explanatory diagram of the labeling process showing a state where a label is attached to a pixel which is adjacent to the first pixel;

FIG. 7C is an explanatory diagram of the labeling process showing a state where labels are attached to all pixels;

FIG. 7D is an explanatory diagram of a labeling process that deals with an image having three domains;

FIG. 7E is an explanatory diagram of the labeling process showing a state where labels are attached to the image, having the three domains;

FIG. 8A is an explanatory diagram showing a procedure for detecting a specific domain;

FIG. 8B is an explanatory diagram showing a procedure for detecting a specific domain in a skin domain state;

FIG. 8C is an explanatory diagram showing a procedure for detecting a skin domain in the specific domain;

FIG. 8D is an explanatory diagram showing a procedure for detecting a specific domain in the case where a photographic subject is a non-clothed child;

FIG. 9A is a flowchart for explaining process A in a domain distinction unit which is included in a photographic image distinction unit;

FIG. 9B is a flowchart for explaining process B in a specific domain estimation unit which is included in the photographic image distinction unit;

FIG. 9C is a flowchart for explaining process C in a skin domain detecting unit which is included in the photographic image distinction unit; and

FIG. 10 is an explanatory diagram showing a photographic image processing apparatus equipped with an informing unit.

### DESCRIPTION OF PREFERRED EMBODIMENTS

Preferred, embodiments of a photographic image processing apparatus in which the photographic image distinction method according to the present invention is adopted will be described hereinbelow.

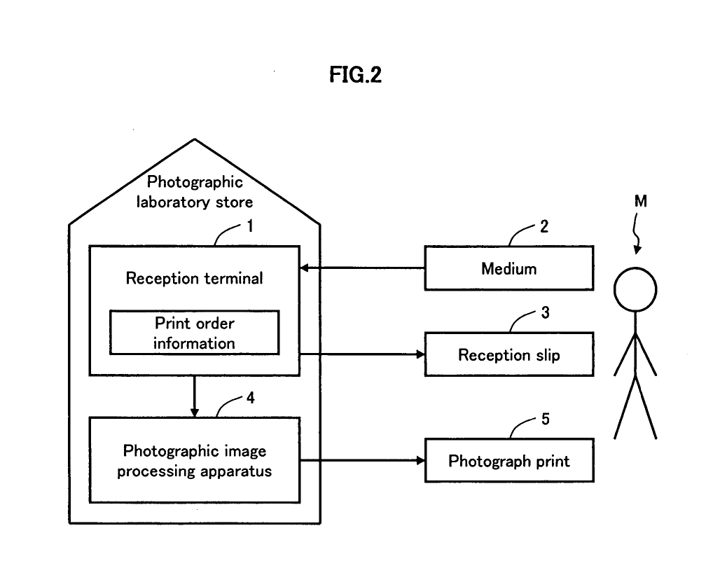

As shown in FIG. 2, a photograph print order system is equipped with a plurality of reception terminals 1 installed in a photographic laboratory store and a photograph printing apparatus that serves as a photographic image processing apparatus 4 which generates photograph prints based on print order information that is inputted to each reception terminal 1.

A customer M comes to the store, inserts a medium 2 in which photographic image data photographed with a digital image-pickup apparatus, for example, such as a digital camera built into a mobile telephone, into a media drive that is attached to a reception terminal 1, and when ID information including a name, a contact, etc., specifying information on the image information to be printed, the number of prints, print size, etc. are inputted through the reception terminal 1, it is arranged so that a reception slip 3 is outputted from a built-in printer.

In the reception terminal 1, print order information is generated based upon the ID information, the specifying information on the images to be printed, the number of prints, the print size, etc., thus inputted, and the print order information is transmitted to the photographic image processing apparatus 4, so that photograph prints 5 are generated based upon the received print order information in the photographic image processing apparatus 4.

When, at, the estimated time for print finish that is printed in the reception slip 3, the customer M shows a clerk at the reception counter of the photographic laboratory store the reception slip 3 and pays, the charge, the photograph prints are handed over.

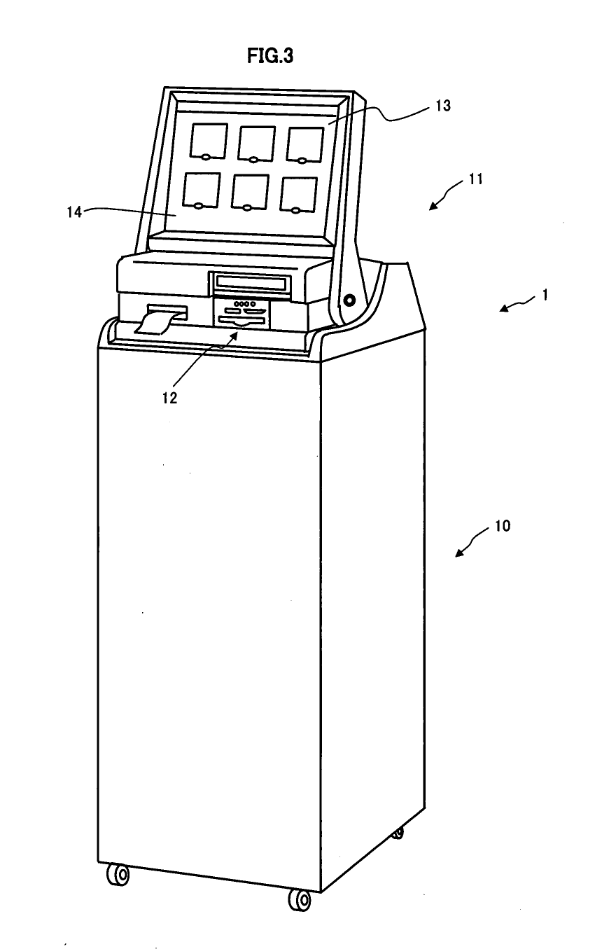

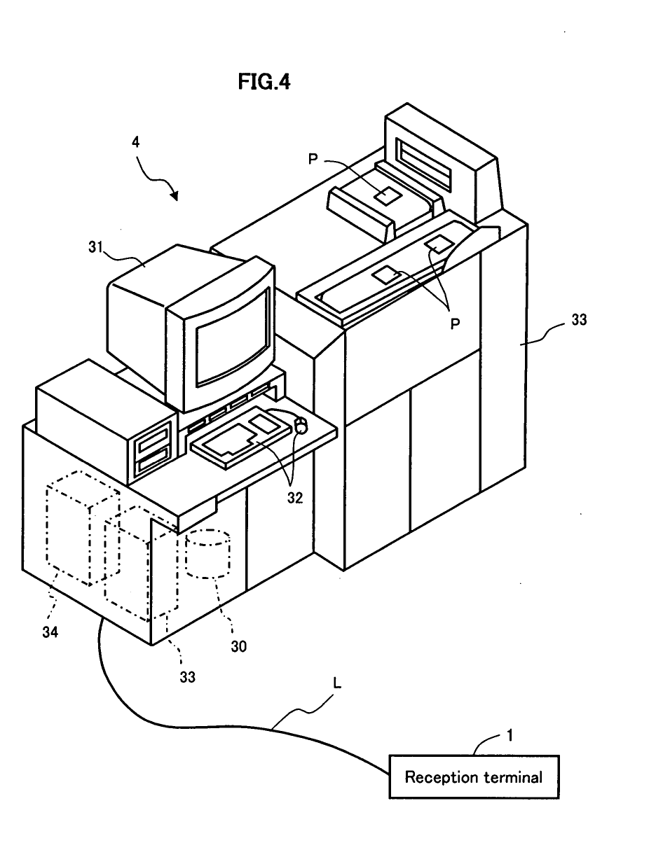

As shown in FIG. 3, the reception terminal 1 is constituted by a case 10 and a photograph order reception processing unit 11 arranged on the upper portion of the case 10, and as shown in FIG. 4, the photograph order reception processing unit 11 and the photographic image processing apparatus 4 are connected to each other via a data-communication line L.

The photograph order reception processing unit 11 is configured by a plurality of kinds of media drives 12 which constitute a data input unit used for reading photographic image data stored in the medium 2 that is one of various kinds of portable media such as a CD, a CF card and an SD memory that a customer possesses, a liquid-crystal-display unit 13 which is a display unit to display the photographic images read by the media drive 12, and a touch-panel 14 or the like that is arranged on the surface of the liquid-crystal-display unit 13 and used as an input unit to input the order data such as the number of prints, print size, etc., with respect to the photographic images displayed on the liquid-crystal-display unit 13.

The photographic image processing apparatus 4 is designed such that photograph prints are generated and outputted in a predetermined order based on a plurality of pieces of print order information transmitted through the data-communication line L from each reception terminal 1.

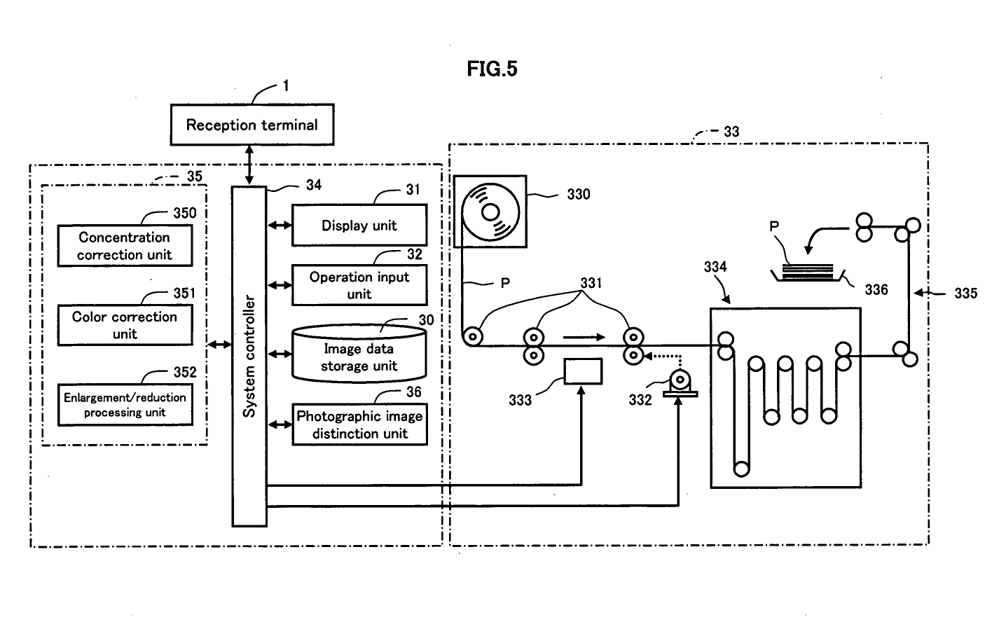

As shown in FIGS. 4 and 5, the photographic image processing apparatus 4 is provided with respective blocks including: an image data storage unit 30 that is configured by a hard disk or the like which stores a series of frame image data included in the print order information that has been inputted from the reception terminal 1, a display unit 31 which displays thumbnail images corresponding to respective frame images based upon the frame image data, an operation input unit 32 equipped with a keyboard or a mouse, and a photograph print unit 33 which exposes printing sheet P based on the data after having been subjected to image processing by an image-processing unit 35, which will be described later, and generates photograph prints.

Moreover, the photographic image processing apparatus 4 is provided with a system controller 34 which controls each of the above-mentioned blocks as a system, based upon an application program installed under management of a predetermined operating system, the image-processing unit 35 which carries out edit-processing on the image data based upon various pieces of operation information inputted through the operation input unit 32 with respect to the photographic images displayed on the display unit 31, or automatically carries out the edit-processing on the image data without the use of the operation input unit 32, a photographic image distinction unit 36 which distinguishes automatically whether any non-clothed portrait image is included in the frame image data included in the print order information, and the like.

The photograph print unit 33 is provided with a paper magazine 330 in which roll-shaped printing sheet P is accommodated, a plurality of printing sheet conveyance rollers 331 that pull out and convey the printing sheet P from the paper magazine 330, a motor 332 that drives the conveyance rollers, 33 1 a print head 333 of a fluorescent beam system that exposes the photosensitive-face of the printing sheet P conveyed by the conveyance rollers 33L, a developing treatment unit 334 that carries out respective processes of developing, bleaching and fixing on the printing sheet P that has been exposed, a drying unit 335 that conveys the printing sheet P that has been subjected to the developing treatment while drying the printing sheet P, and a discharge unit 336 which discharges the dried printing sheet P as a finished print.

The printing sheet P pulled out from the paper magazine 330 is cut into a predetermined print size by a cutter (not shown) arranged at any position before and after the developing treatment, and is outputted to the discharge unit 336.

The print head 333 is configured by a laser-type exposure optical system that modulates bundle of rays that are outputted from lasers having respective wavelengths of red, green and blue and scanned by a rotating polygon mirror, based upon respective pieces of pixel data corresponding to R component, G component and B component of the photographic image data that has been edit-processed by the image-processing unit 35, which will be described later, so that the corresponding photographic image is exposed on the printing sheet P.

The system controller 34 is provided with a ROM in which a program that operates the photographic image processing apparatus 4 is stored, a RAM used as a data-processing domain, as well as for editing photographic image data, a CPU which executes the program, and peripheral circuits, and controls each of the blocks of the photographic image processing apparatus 4 based on the program.

The image-processing unit 35 is equipped with a concentration correction unit 350 that carries out gray level correction on each of the photographic images displayed on the display unit 31, a color correction unit 351 that adjusts a color-balance, and an enlargement/reduction processing unit 352 that carries out an enlarging or reducing process on the subject image.

Upon selection of a mode that automatically corrects an image by the operator through the operation input unit 32, the system controller 34 activates the image-processing unit 35 to carry out required image processing operations such as concentration correction and color-balance correction in succession on the frame images included in the print order information that has been inputted from the reception terminal 1, while it also activates the photographic image distinction unit 36 to cause the unit 36 to automatically distinguish whether or not the image data include any non-clothed portrait image.

Here, upon selection of a mode that carries out manual correction on an image by the operator through the operation input unit 32, image processing and photographic image distinction processing are activated on the basis of each piece of print order information by the operation of an operation button displayed on the operation screen, and thumbnail images corresponding to the respective frame images included in the print order information are displayed on the display unit 31. The operator manually carries out an image correction treatment on each of the images displayed on the display unit 31, and also performs inspection processing so as to prevent harmful images from being printed out.

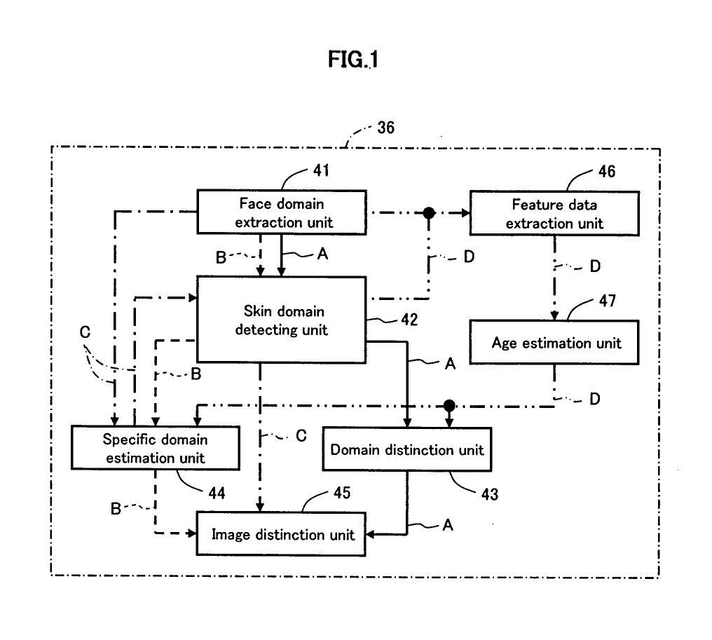

As shown in FIG. 1, the photographic image distinction unit 36 is provided with a face information extraction unit 41 that detects a person's face domain from the inputted color image data, a skin domain detecting unit 42 that detects a person's skin domain from the image data, and a domain distinction unit 43 that distinguishes the domain continuity between a face domain and a skin domain, a specific domain estimation unit 44 that estimates a specific domain corresponding to a person's specific part from the image data, and an image distinction unit 45 that distinguishes whether or not the image data include any non-clothed portrait image.

In each of these processing units, as shown in FIG. 1, it is distinguished whether or not any non-clothed portrait image is included, by processing data in any one of three processing routes indicated by process A (solid line arrow), process B (dotted line arrow) and process C (dashed-dotted line arrow); and each of these processes will be described later in detail.

Furthermore, the photographic image distinction unit 36 is provided with a feature data extraction unit 46 that extracts pose feature data from a face domain or a skin domain, and an age estimation unit 47 that estimates a photographic subject's age based upon the pose feature data, and as shown by Process D (dashed-two dotted line arrow) in FIG. 1, by using the age estimation unit 47, the age of the subject is added to the result of distinction as to whether or not any portrait image without clothes is included, in the image distinction unit 45.

The face information extraction unit 41 detects a person's face domain from the inputted color image data, and it is configured such that color difference data of the skin of a face domain, a direction of the face domain, and, a size of the, face domain can be extracted.

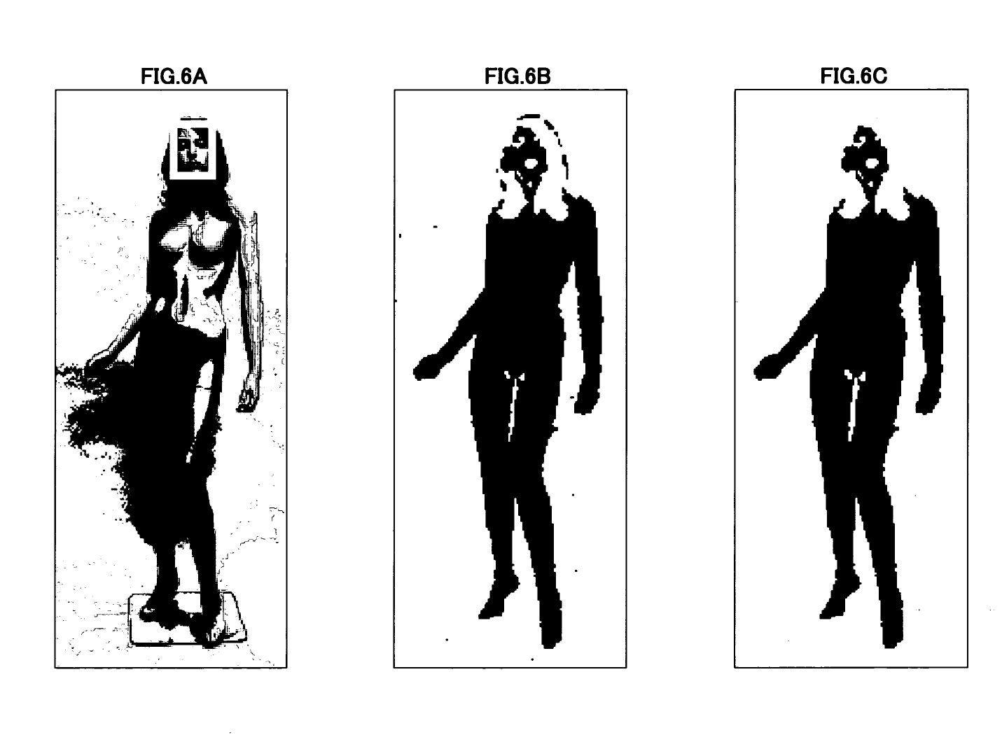

Detection of the face, domain of a person from the inputted color image data can be achieved by using known techniques, such as a technique in which whether or not the outline obtained based upon the concentration edge and color edge that have been extracted from color image data, corresponds to a face domain is detected based upon the pattern recognition technology in which the degree of coincidence with respect to a plurality of element arrangement patterns such as an outline of the face domain, eyes, a nose, a mouth and an ears, prepared beforehand, is evaluated. As a result, for example, as shown in FIG. 6A, the detected face domain is displayed with a rectangular frame.

The color difference data of the skin of a face domain are calculated as a Cb component (color difference of brightness and blue) and a Cr component (color difference of brightness and red) of the YCC color system that are obtained by calculating an average value for respective R components, G components and B components of all the pixels constituting the detected face domain and substituting the average value of the respective components for [Equation 1] to be converted into values of the YCC color system.

Hereinafter, the Cb component of the color difference data of the skin of a face domain is denoted as Cbs, the Cr component thereof is denoted as Crs, and these are denoted as (Cbs, Crs) in combination. In addition, by using only the Cb component and the Cr component without using a Y component (brightness), light and dark factors, which are unnecessary in identifying a face domain and a skin domain, can be excluded.
Y=0.29891×R+0.58661×G+0.11448×B
Cb=−0.16874×R−0.33126×G+0.50000×B
Cr=0.50000×R−0.41869×G−0.08131×B [Formula 1]

The face information extraction unit 41 calculates relative positional relationships between a plurality of elements such as an outline, eyes, a nose, a mouth and ears of the detected face domain, for example, as coordinates information, and by comparing the coordinates information thus calculated with direction patterns of a face that are preliminarily registered as face direction patterns corresponding to relative positions between various elements, the direction of the face domain is obtained, and the number of all the pixels in the detected face domain is calculated as the size of the face domain. For example, the area of the rectangular frame in FIG. 6A is calculated as the size of a face domain.

The skin domain detecting unit 42 is configured such that a domain that is correlated with the color difference data of the skin extracted in the face information extraction unit 41 is detected as a skin domain from the color image data or a specific domain which will be described later.

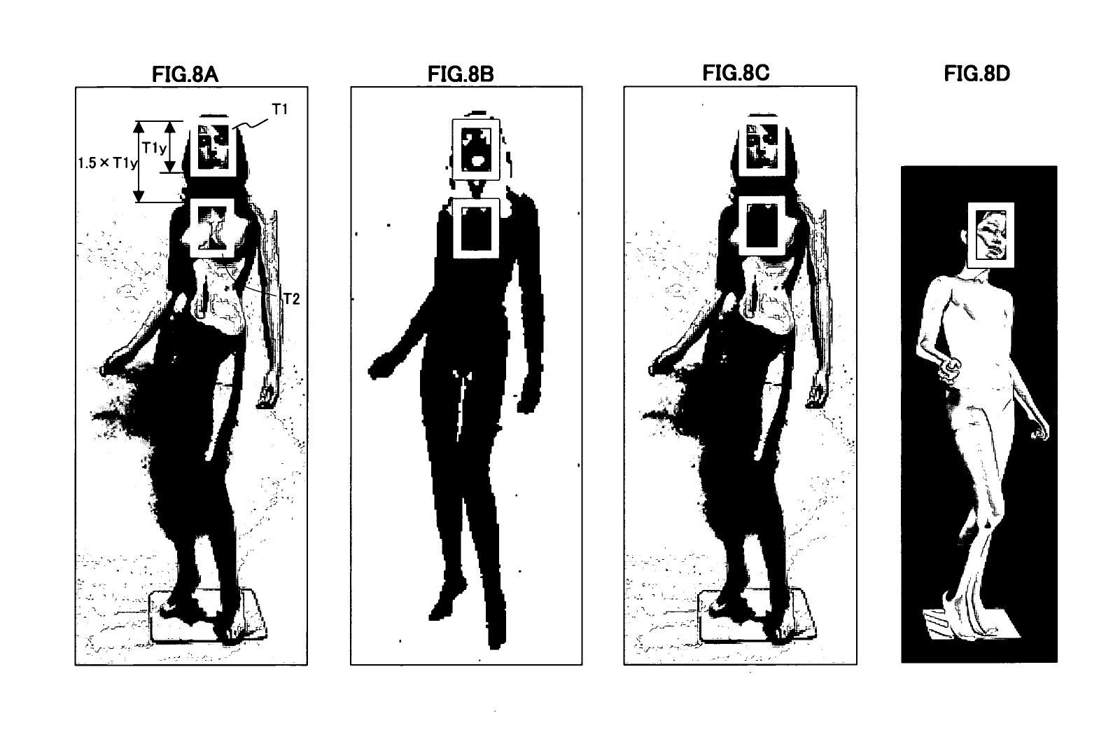

The detailed explanation is given as follows; With respect to all the pixels in the color image data or all the pixels within the specific domain indicated as a rectangular area T2 in FIG. 8A, color difference data (Cbn, Crn) of each pixel are calculated. Here, n represents a number of a pixel, and ranges from 1 (minimum value) to the number of pixel data to be calculated (maximum value).

Next, a distance Dn between the color difference data (Cbn, Crn) calculated for each pixel and the color difference data (Cbs, Crs) of the skin of a face domain is calculated based on [Equation 2], and the resulting value is subjected to a binarizing process depending on whether the distance Dn with respect to each pixel is greater or smaller than a preset threshold value.

As a result of the binarizing process, a domain in which the distance Dn becomes smaller than the threshold value is detected as the skin domain. Here, the calculation of the threshold value used for the binarizing process is carried out, for example, by using a distinction analyzing method or the like in which all the pixels to be subjected to the binarizing process are divided into two classes, and the threshold value is determined so that the separation between the two classes becomes largest.
Dₙ=\sqrt{(C_{bn}−C_{bs})²+(Cᵣₙ−Cᵣₛ)²} [Formula 2]

The result obtained through carrying out the binarizing process on all the pixels of the color image data shown in FIG. 6A to detect the skin domain, is shown in FIG. 6B. In FIG. 6B, the skin domain is indicated by a portion which is colored with black, and domains other than the skin domain are indicated by gray portions (although gray in the figure, these are white in actual operation processing).

With the above-described configuration, since color difference data of the corresponding person's skin is extracted from the skin of the face domain extracted by the face information extraction unit, a skin domain detecting unit can extract the skin domain of the person, accurately based upon the color difference data regardless of the presence or absence of shades of contrast in the skin domain. Therefore, it becomes possible to reliably detect the skin domain even when there is a variety of color difference information on the skin domain depending on races.

The domain distinction unit 43 is designed such that the domain continuity between the face domain detected by the face information extraction unit 41 and the skin domain detected by the skin domain detecting unit 42 are distinguished, and the skin domain detected by the skin domain detecting unit 42, is subjected to labeling processing, and based upon the result, the domain continuity is distinguished.

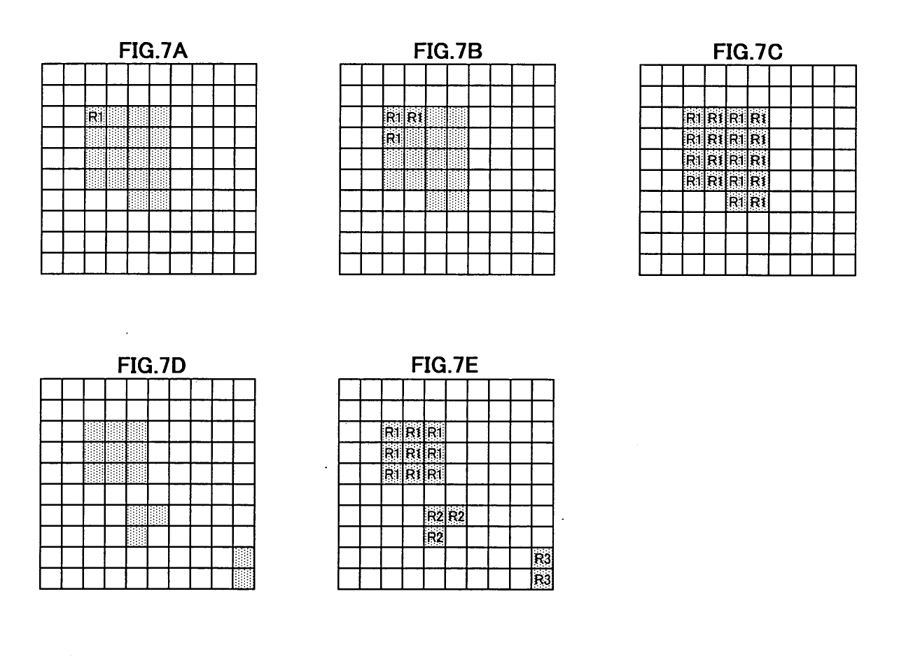

The labeling processing is a process in which, by using the following processes, while pixels that are coupled to one another in a subject image are regarded as one domain, that is, a group of pixels included within predetermined threshold values are regarded as one domain, a common label is successively applied to these. In other words, as shown in FIG. 7A, by finding a pixel to which no label is attached and which satisfies predetermined conditions (here, skin domain colored with black in the binarizing process), a new label R1 is added thereto so that, as shown in FIG. 7B, when, upon scanning a pixel coupled to the pixel to which the new label R1 has been added, the pixel satisfies predetermined conditions, the same label is added thereto. As shown in FIG. 7C, the above-described processes are repeated until pixels to which labels should be added no longer exists within the image.

For example, when the above-described processes are carried out on an image having three skin domains as shown in FIG. 7D, the labels R1 to R3 are attached to the three skin domains located within the respective ranges of predetermined threshold values, as shown in FIG. 7E. Therefore, when the labeling processing is carried out on skin domains, different labels are attached to the respective skin domains located in the color image data.

The distinguishing process of domain continuity is carried out, for example, in the following manner. A searching process is carried out on arbitrary pixels within a face domain, and the label attached to the pixel first searched is determined as the label for the face domain, so that a skin domain to which the same label as that of the face domain is attached is detected as a domain having domain continuity to the face domain.

With respect to image data detected as a skin domain as shown in FIG. 6B, the result of the distinguishing process of domain continuity carried out thereon is shown in FIG. 6C. The portion colored with black in FIG. 6C is the skin domain detected as the domain having domain continuity with the face domain.

The specific domain estimation unit 44 is designed such that the position of each of specific domains corresponding to predetermined specific parts such as chest and abdomen, of the person in the image can be estimated based on the direction of a face domain and the size thereof.

For example, as shown in FIG. 8A, a rectangular area T2, which corresponds to an area obtained by moving the rectangular area T1 obtained from the detection of the face domain to the torso side of the subject by 1.5 times the longitudinal width T1y of the rectangular area T1, is estimated as a specific domain corresponding to the breasts that is a specific part of the person in the image.

In the above-described example, it is estimated based upon the result of statistical analyses on a large number of person's images that the area obtained by moving from the face domain to the torso side of the subject by 1.5 times of the longitudinal width of the face domain, corresponds to the breasts that form a specific domain; however, of course, another configuration adopting another different magnification, not 1.5 times, may be used in moving the area, depending on the specific portion to be estimated. For example, on the basis of a plurality of subject's typical poses, relative positional relationships between specific parts and the direction and size of the face domain may be prepared as estimation data; thus, the location of each of the specific parts can be estimated based on the direction and size of the face domain of the subject.

Although the torso side of the subject is located in the downward direction in the above-described example, the torso side of a subject is not necessarily located in the downward direction, depending on photographic images. For example, in the case of a portrait image in which a person lies down with the head positioned on the left side, the torso side is located in a lateral direction. In such a case, a specific domain is estimated based upon the direction of the face domain. That is, the direction of the face domain is obtained from the relative positions between the elements forming the face, and when the mouth is located in the right side of eyes, the rectangular area as a result of the movement toward the torso side (for example, right side) of the subject is estimated as, a specific domain corresponding to the breasts that are a specific part of the person in the image.

The image distinction unit 45 is designed such that based upon either one of the area ratio between a face domain and a skin domain distinguished as a continuous domain in the domain distinction unit 43 and the area ratio between a skin domain and a non-skin domain in a specific domain estimated by the specific domain estimation unit 44 based upon detected information by the skin domain detecting unit 42, a distinguishing process as to whether or not any non-clothed portrait image is included in color image data is carried out.

Here, the ratio of the face to a human's whole body is virtually the same; therefore, in the case where in a portrait image, a subject does not wear clothes, the area ratio between the face domain and the skin domain becomes virtually the same, while in contrast, in the case where the subject wears clothes, the area ratio becomes unnaturally small because the skin domain is reduced by the portion corresponding to the clothes. By conducting statistical analyses on many non-clothed portrait images based upon this fact, a face domain threshold value that forms a standard based on which determination is made as to whether or not the person wears clothes is calculated.

Moreover, when, in a certain image, the area ratio between the face domain and the skin domain is larger than the face domain threshold value, it is determined that the image includes any non-clothed portrait image; in contrast, when the areas ratio between the face domain and the skin domain is smaller than the face domain threshold value, it is determined that the image does, not include any non-clothed portrait image. In addition, the area of the face domain may be given as either the rectangular area shown in FIG. 6A or the area of the skin domain colored with black in FIG. 6B located inside the rectangular area shown in FIG. 6A.

In the case where the specific domain corresponds to the breasts domain, since almost all the pixels in the domain belong to the skin domain in the case of wearing no clothes, the area ratio of the skin domain to the non-skin domain within the specific domain becomes as large as almost 100%; however, in the case of wearing clothes, the area ratio becomes smaller since the portion of the clothes within the domain does not form the skin domain. In accordance with this tendency, based upon the fact that the area ratio between the skin domain and the non-skin domain within a specific domain becomes virtually the same among different portrait images, statistical analyses are carried out on various specific domains of a large number of non-clothed portrait images, so that a specific domain threshold value that forms a standard based on which determination is made as to whether or not the person wears clothes is calculated.

Therefore, in the case where in a certain image, the area ratio between the skin domain and the non-skin domain in a specific domain is larger than the specific domain threshold value, the image distinction unit 45 determines that a non-clothed portrait image is included in the image, while when the area ratio between the skin domain and the non-skin domain in the specific domain is smaller than the specific domain threshold value, the image distinction unit 45 determines that there is not any non-clothed portrait image included in the image.

The feature data extraction unit 46,is configured such that pose feature data is extracted from the face domain extracted by the face information extraction unit 41 or the skin domain detected by the skin domain detecting unit 42, and various pieces of information, such as information relating to skin contour and information relating to the outlines, for example, the outline of a face, a hairstyle, the height of a nose, the color of lips, wrinkles, and the shape of eyebrows, or the shape of breasts, the outline of torso and arm and leg, the ratio between head and height, and the like, can be extracted as pose feature data.

The extraction of such pose feature data can be carried out by using a known technique, such as a sampling method in which, based on the position of each of the constituent elements of a face, the positions of feature points are set more densely as they are located more closely to the constituent element, while the positions of feature points are set more thinly as they are located more apart from the constituent element, and an extraction method in which a Gabor wavelet transform is executed on the preset feature points so that periodicity and the directivity of the shade characteristic on the periphery of the feature point are extracted as pose feature data.

The age estimation unit 47 is designed such that a subject's age can be estimated based on the pose feature data extracted by the feature data extraction unit 46 and the pose feature data preliminarily sampled from every age group.

The age estimation unit,47 is provided with, for example, a data base in which a typical sample image among many sample images for every constituent element or a sample image obtained by averaging many sample images for every constituent element is preliminarily registered as pose feature data for every age group, and by comparing the pose feature data extracted by the feature data extraction unit 46 with the pose feature data preliminarily registered in the database, the age group is estimated for every constituent element, and the age group estimated by the most constituent elements is estimated as the subject's age group.

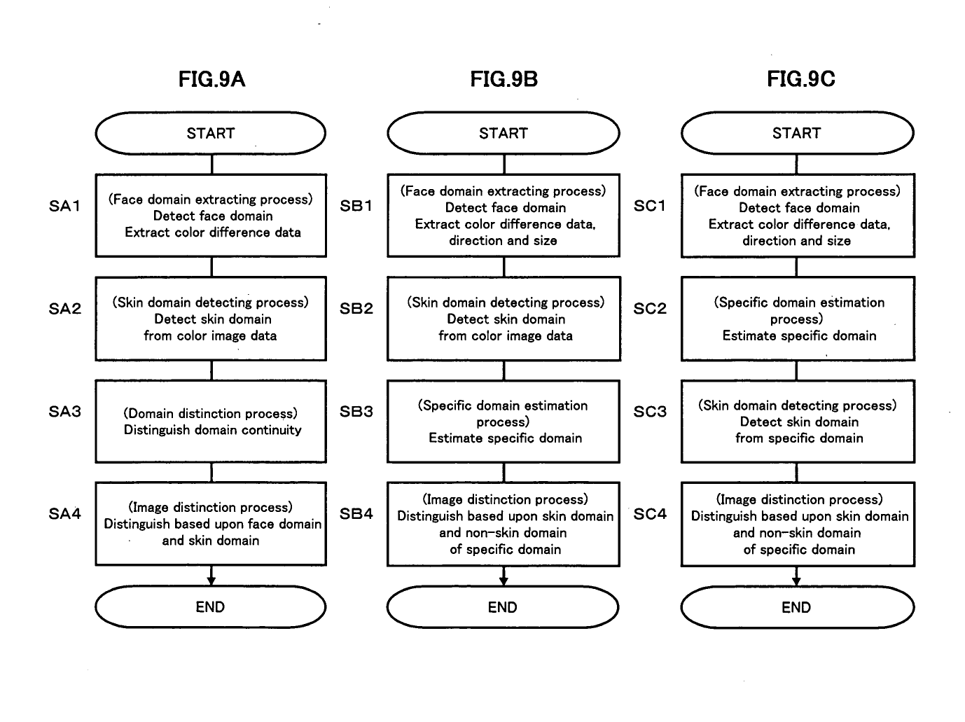

Referring to the flowcharts shown in FIGS. 9A to 9C, processing processes of the respective processing units of the photographic image distinction unit 36 will be described hereinbelow in accordance with each of routes of process A (solid line arrow), process B (dotted line arrow) and process C (dashed-dotted line arrow) as shown in FIG. 1.

In process A, as shown in FIG. 9A, the face domain extraction unit 41 detects a face domain (domain surrounded by a rectangular frame in the figure), as shown in FIG. 6A, from inputted color image data, and extracts color difference data of the face domain from the pixels that form the face domain (SA1).

Next, in the skin domain detecting unit 42, as shown in FIG. 6B, a skin domain (domain colored with black in the figure) is detected from the color image data (SA2), and the domain continuity of the skin domain is distinguished by the domain distinction unit 43, so that, as shown in FIG. 6C, a skin domain in which the face domain is included (domain colored with black in the figure) is detected (SA3).

Moreover, the image distinction unit 45 distinguishes whether or not any non-clothed portrait image is included in the color image data based upon the ratio of areas,between the face domain and the skin domain (SA4).

In process B;, as shown in FIG. 9B, the face domain extraction unit 41 detects a face domain (domain surrounded by a rectangular frame in the figure), as shown in FIG. 6A, from inputted color image data, and extracts color difference data, the direction and the size of the face domain from the pixels that form the face domain (SB1).

Next, in the skin domain detecting unit 42, as shown in FIG. 6B, a skin domain (domain colored with black in the figure) is detected from the color image data (SB2), and based upon the direction and size of the face domain, the specific domain estimation unit 44 estimates a specific domain dower area of the domain surrounded by the rectangular frame in the figure) of the portrait image included in the color image data as shown in FIG. 8B (SB3).

Moreover, the image distinction unit 45 distinguishes whether or not any non-clothed portrait image is included in the color image data based upon the area ratio between the skin domain (the lower area colored with black of the domain surrounded by the rectangular frame in FIG. 8C) and the non-skin domain (the lower area that is not colored with black in the domain surrounded by the rectangular frame in FIG. 8C) within the above-mentioned specific domain (SB4).

In process C, as shown in FIG. 9C, the face domain extraction unit 41 detects a face domain (domain surrounded by the rectangle frame in the figure) from inputted color image data as shown in FIG. 6A, and extracts the color difference data, the direction and the size of the above-mentioned face, domain from the pixels, which form the face domain (SC1).

Next, the specific domain estimation unit 44 estimates a specific domain (lower area of the domain surrounded by the rectangular frame in the figure) of the portrait image included in the color image data as shown in FIG. 8A based upon the direction and the size of the face domain (SC2), and the skin domain detecting unit 42 detects a skin domain (area colored with black in the domain surrounded by the rectangular frame in the figure), as shown in FIG. 8C, from the image data of the specific domain (SC3).

Moreover, the image distinction unit 45 distinguishes whether or not any non-clothed portrait image is included in the color image data based upon the area ratio between the skin domain (the lower area colored with black of the domain surrounded by the rectangular frame in FIG. 8C) and the non-skin domain (the lower area that is not colored with black in the domain surrounded by the rectangular frame in FIG. 8C) within the specific domain (SC4).

In the photographic image processing apparatus 4 as described above, a photographic image distinction program relating to any of the following combinations or all the programs are installed, and each of the processing units of the photographic image distinction unit 36 is achieved by the photographic image distinction program and the CPU and peripheral circuits of the system controller that executes the program.

The first photographic image distinction program relates to a photographic image distinction program that causes a computer to execute the following processes: a face information extracting process in which a face domain of a person is detected from inputted color image data so that color difference data of the skin is extracted from the face domain; a skin domain detecting process in which an area that is correlated with the color difference data of the skin extracted in the face information extracting process is detected as the skin domain from the color image data; a domain distinction process which distinguishes the domain continuity between the face domain and the skin domain detected in the skin domain detecting process; and an image distinction process which calculates the ratio of areas between the face domain an& the skin domain that are distinguished as a continuous domain in the domain distinction process, so that based upon the ratio of the areas, it is distinguished whether or not any non-clothed portrait image is included in the color image data.

The second photographic image distinction program relates to a photographic image distinction program that causes a computer to execute the following processes: a face information extracting process in which a face domain of a person is detected from inputted color image data so that color difference data of the skin, the direction and the size are extracted from the face domain; a skin domain detecting process in which an area that is correlated with the color difference data of the skin extracted in the face information extracting process is detected as the skin domain from the color image data; a specific domain estimating process in which based upon the direction and the size of the face domain, a specific domain corresponding to a specific portion of the person is estimated; and an image distinction process which calculates the ratio of areas between the skin domain and the non-skin domain in the specific domain that is estimated in the specific domain estimating process, based upon the detected information in the skin domain detecting process, so, that based upon the ratio of the areas, it is distinguished whether or not any non-clothed portrait image is included in the color image data.

The third photographic image distinction program relates to a photographic image distinction program that causes a computer to execute the following processes: a face information extracting process in which a face domain of a person is detected from inputted color image data so that color difference data of the skin, the direction and the size are extracted from the face domain; a specific domain estimating process in which based upon the direction and the size of the face domain, a specific domain corresponding to a specific portion of the person is estimated; a skin domain detecting process in which an area that is correlated with the color difference data of the skin extracted in the face information extracting process is detected as the skin domain from the specific domain; and an image distinction process which calculates the ratio of areas between the skin domain and the non-skin domain in the specific domain, so that based upon the ratio of the areas, it is distinguished whether or not any non-clothed portrait image is included in the color image data.

Moreover, the fourth photographic image distinction program relates to a photographic image distinction program that causes a computer to execute the following processes: a feature data extracting process that extracts pose feature data from the face domain extracted in the face information extracting process or the skin domain detected in the skin domain detecting process; and an age estimating process that estimates the photographic subject's age based on the pose feature data extracted in the feature data extracting process and the pose feature data preliminarily sampled for every age group.

Other embodiments will be described hereinafter. In the above embodiments, the configuration has been described in which the pose feature data to be extracted by the feature data extraction unit 46 is extracted from the face domain; however, the pose feature data may be extracted from a domain other than the face domain. For example, as long as they belong to a skin domain, constituent factors such as a height, the size and shape of breasts, the outline, the size, etc. of waist and hips, may be extracted as the pose feature data.

The photographic image distinction unit 36 may have a process selecting unit that selects which one of the process A, the process B and the process C described in the above embodiments to be executed, and when executing any one of the process A, the process B and the process C, makes selection as to whether or not the process D described in the above embodiment should be executed at the same time.

For example, the process selecting unit may preliminarily display processes that can be executed on the display unit 31 of the photographic image processing apparatus 4, and the operator may select and input a process to be executed through the operation input unit 32.

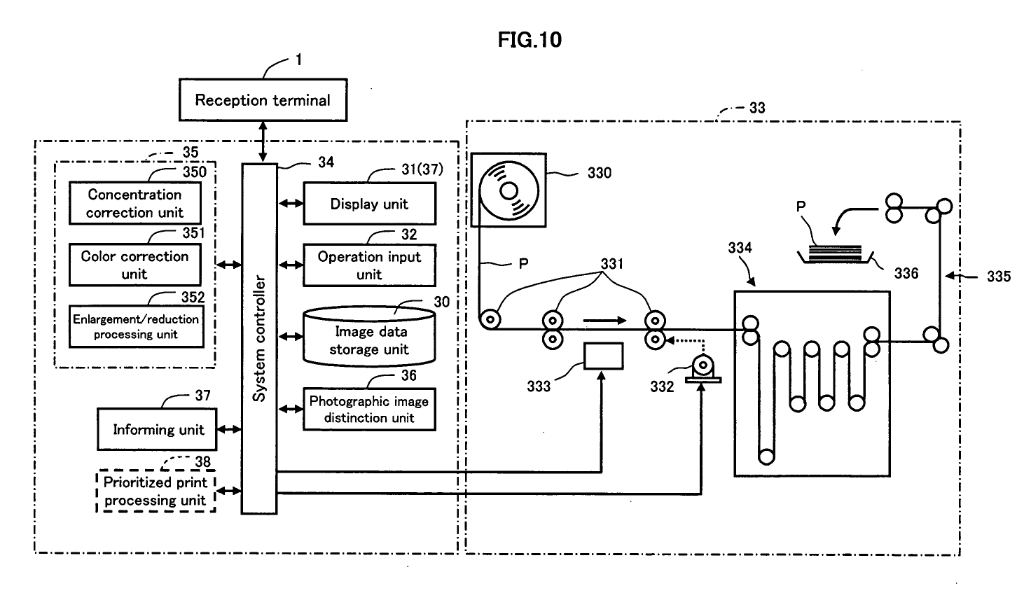

As shown in FIG. 10, the photographic image processing apparatus 4 may be provided with an informing unit 37 which, upon determination by the photographic image distinction unit 36 that a non-clothed portrait image is included in frame images included in print order information transmitted from each of the reception terminals 1, calls for the attention of the operator of the photographic image processing apparatus 4.

More specifically, the informing unit 37 may be configured as a warning print output unit which, when it is distinguished by the photographic image distinction unit 36 that a non-clothed portrait image is included, outputs an index print for warning, that is, a reduced print on a sheet of recording medium of all the frame images included in the corresponding print order information, onto the uppermost face of the outputted photograph prints, i.e., the latest outputted photograph print.

Moreover, the informing unit 37 may be configured as a display unit 31 which, when it is distinguished by the photographic image distinction unit 36 that a non-clothed portrait image is included, displays a message calling for the operator's attention.

Furthermore, as shown in FIG. 10, instead of the informing unit 37, or in addition to the informing unit 37, the photographic image processing apparatus 4 may have a prioritized print processing unit 38 which, upon determination by the photographic image distinction unit 36 that a non-clothed portrait image is included in frame images included in a plurality of pieces of print order information transmitted from each of the reception terminals 1, suspends the photograph print processing on the corresponding print order information, and carries out by priority the photograph print processing on the other print order information.

In the above embodiments, the configuration of the photographic image processing apparatus 4 that processes photographic image data inputted through the reception terminal 1 has been described; however, the photographic image processing apparatus 4 may include a film scanner so that frame images stored in a photograph film received from a customer M may be read through the film scanner.

In the above embodiments, as shown in FIG. 2, the configuration of the photograph print order system has been described in which the reception terminal 1 installed in a photo laboratory store receives each customer M, that is, an automatic reception system; however, the photograph print order system may have a configuration other than this configuration.

For example, a salesclerk who is in charge of the job in the photograph laboratory store receives a storage medium or a photograph film in which picked-up image data has been stored from a customer M, and the finished photograph prints may be handed over to the customer M, that is, a system in which the salesclerk takes care of the customer M may be used.

Moreover, another system may be used in which a customer M orders printing of picked-up image data via a cellular phone, the Internet, etc. More specifically, the customer M may transmit the picked-up image data to a photo laboratory store or a WEB server or the like that supervises a large number of photo laboratory stores to place an order for printing of the picked-up image data from a remote place. Settlement of the charge is performed through payment by credit card via a cellular phone, the Internet, etc. In this system, when the photograph print is finished, the photo laboratory store that has prepared the print informs the customer M of the fact that the photograph print is ready directly through his or her cellular phone, or by way of the WEB server, or, sends mails informing the fact to the, customer M.

It should be understood that while the above embodiments illustrate the present invention, they are exemplary only, and any modifications may be made on the specific structures of each of the blocks, within the functions and effects produced by the present invention.

What is claimed is:

1. A photographic image distinction method comprising:
a face information extracting step of detecting a face domain of a person from inputted color image data and extracting color difference data of the skin from the face domain;
a skin domain detecting step of detecting an area that is correlated with the color difference data of the skin extracted in the face information extracting step as a skin domain from the color image data;
a domain distinction step of distinguishing domain continuity between the face domain and the skin domain detected in the skin domain detecting step; and
an image distinction step of calculating the ratio of areas between the face domain and the skin domain that are distinguished as a continuous domain in the domain distinction step, and based upon the ratio of the areas, distinguishing whether or not any non-clothed portrait image is included in the color image data.

2. The photographic image distinction method according to claim 1 further comprising:
a feature data extracting step of extracting pose feature data from the face domain extracted in the face information extracting step or from the skin domain detected in the skin domain detecting step; and
an age estimating step of estimating the photographic subject's age based on the pose feature data extracted in the feature data extracting step and pose feature data preliminarily sampled for every age group.

3. A photographic image distinction method comprising:
a face information extracting step of detecting a face domain of a person from inputted color image data and extracting color difference data of the skin, the direction and the size from the face domain;
a skin domain detecting step of detecting an area that is correlated with the color difference data of the skin extracted in the face information extracting step as a skin domain from the color image data;
a specific domain estimating step of estimating a specific domain corresponding to a specific portion of the person based upon the direction and the size of the face domain; and
an image distinction step of calculating the ratio of areas between the skin domain and the non-skin domain in the specific domain estimated in the specific domain estimating step, based upon the detected information in the skin domain detecting step, and distinguishing, based upon the ratio of the areas, whether or not any non-clothed portrait image is included in the color image data.

4. The photographic image distinction method according to claim 3, further comprising:
a feature data extracting step of extracting pose feature data from the face domain extracted in the face information extracting step or from the skin domain detected in the skin domain detecting step; and
an age estimating step of estimating the photographic subject's age based on the pose feature data extracted in the feature data extracting step and pose feature data preliminarily sampled for every age group.

5. A photographic image processing apparatus comprising:
a face information extraction unit which detects a face domain of a person from inputted color image data and extracts color difference data of the skin from the face domain;
a skin domain detecting unit which detects an area that is correlated with the color difference data of the skin extracted by the face information extraction unit as a skin domain from the color image data;
a domain distinction unit which distinguishes domain continuity between the face domain and the skin domain detected by the skin domain detecting unit; and
an image distinction unit which, calculates the ratio of areas between the face domain and the skin domain that are distinguished as a continuous domain by the domain distinction unit, and based upon the ratio of the areas, distinguishes whether or not any non-clothed portrait image is included in the color image data.

6. The photographic image processing apparatus according to claim 5, further comprising:
a feature data extraction unit that extracts pose feature data from the face domain extracted by the face information extraction unit or the skin domain detected by the skin domain detecting unit; and
an age estimation unit that estimates the photographic subject's age based on the pose feature data extracted by the feature data extraction unit and pose feature data preliminarily sampled for every age group.

7. A photographic image processing apparatus comprising:
a face information extraction unit which detects a face domain of a person from inputted color image data and extracts color difference data of the skin, the direction and the size from the face domain;
a skin domain detecting unit which detects an area that is correlated with the color difference data of the skin extracted by the face information extraction unit as a skin domain from the color image data;
a specific domain estimation unit which, based upon the direction and the size of the face domain, estimates a specific domain corresponding to a specific portion of the person; and
an image distinction unit which calculates the ratio of areas between the skin domain and the non-skin domain in the specific domain that is estimated by the specific domain estimation unit, based upon the detected information by the skin domain detecting unit, and based upon the ratio of the areas, distinguishes whether or not any non-clothed portrait image is included in the color image data.

8. The photographic image processing apparatus according to claim 7, further comprising:
a feature data extraction unit that extracts pose feature data from the face domain extracted by the face information extraction unit or the skin domain detected by the skin domain detecting unit; and
an age estimation unit that estimates the photographic subject's age based on the pose feature data extracted by the feature data extraction unit and pose feature data preliminarily sampled for every age group.
